(19) United States
(12) Patent Application Publication
(10) Pub. No.: US 2003/0096892 A1
(43) Pub. Date: May 22, 2003

(54) Enhanced phase change composition for rub-off reduction

(76) Inventor: Dana G. Marsh, Newark, NY (US)

Correspondence Address: F. Lindsey Scott, Law Office of F. Lindsey Scott, Suite B, 2329 Coit Road, Plano, TX, 75075, US

(21) Appl. No.: 10/190,803

(22) Filed: Jul. 8, 2002

Related U.S. Application Data
(60) Provisional application No. 60/310,887, filed on Aug. 8, 2001.

(51) Int. Cl. C08K 5/17; C08K 5/33; C08K 5/04; C08K 5/09

(52) U.S. Cl. 524/236; 524/394; 524/275; 524/487

(57) ABSTRACT

An enhanced phase change composition for rub-off reduction from a substrate bearing a toner image consists essentially of at least one polymeric material, wax or blends thereof in combination with a friction reducing material with the combined materials having a melting point from about 80 to about 130° C., a melting point range of less than about 15° C., a static coefficient of friction less than about 0.62, a crystalline form as a solid, and being substantially odorless as a solid.

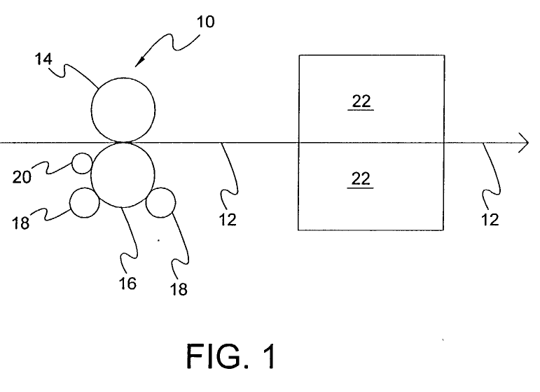

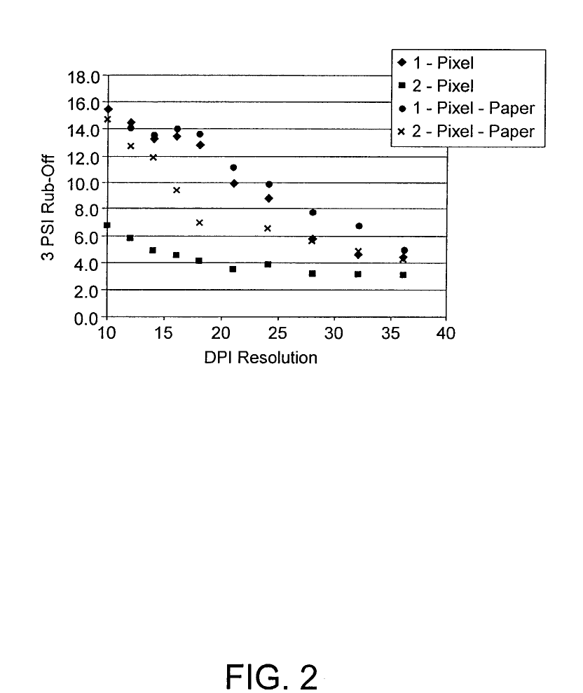

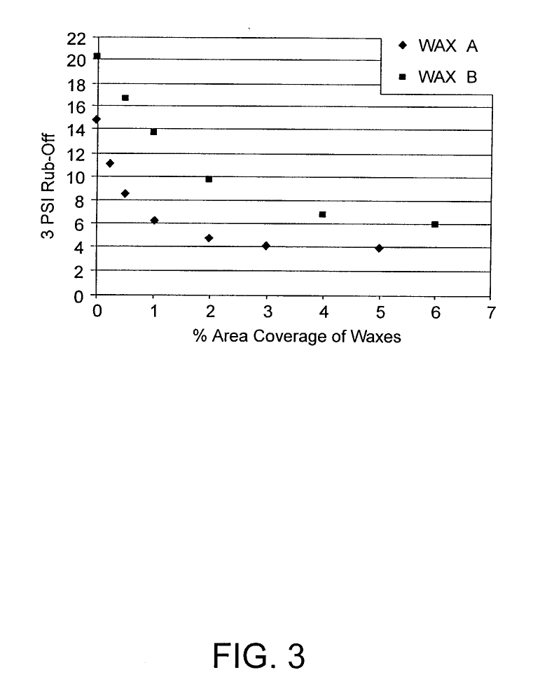

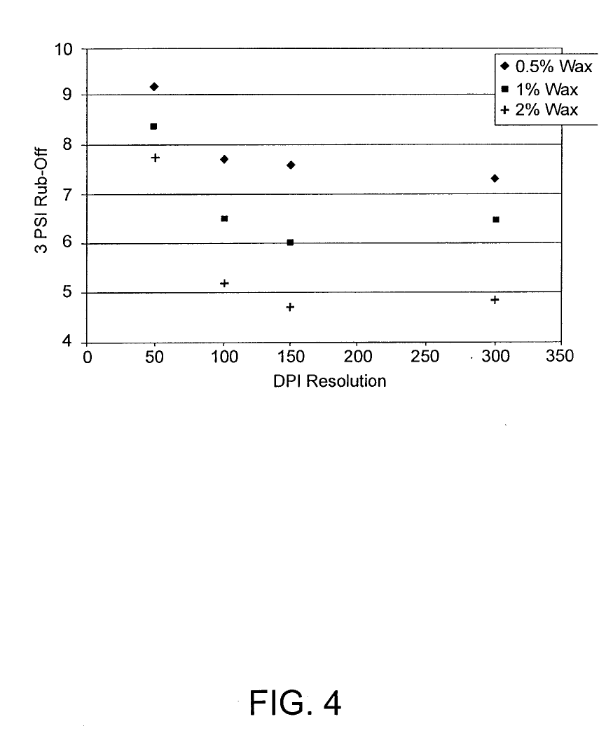

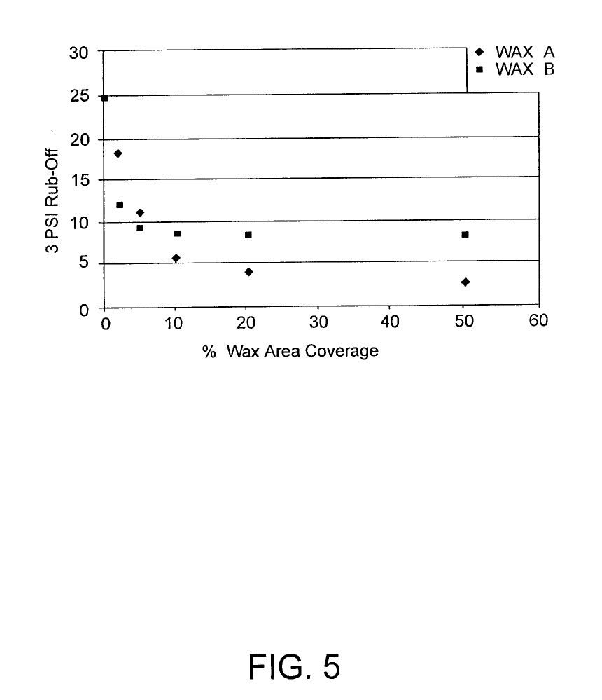

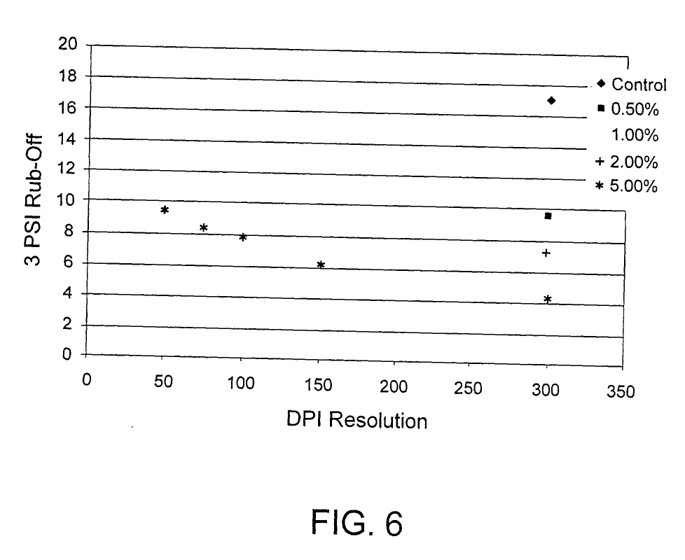

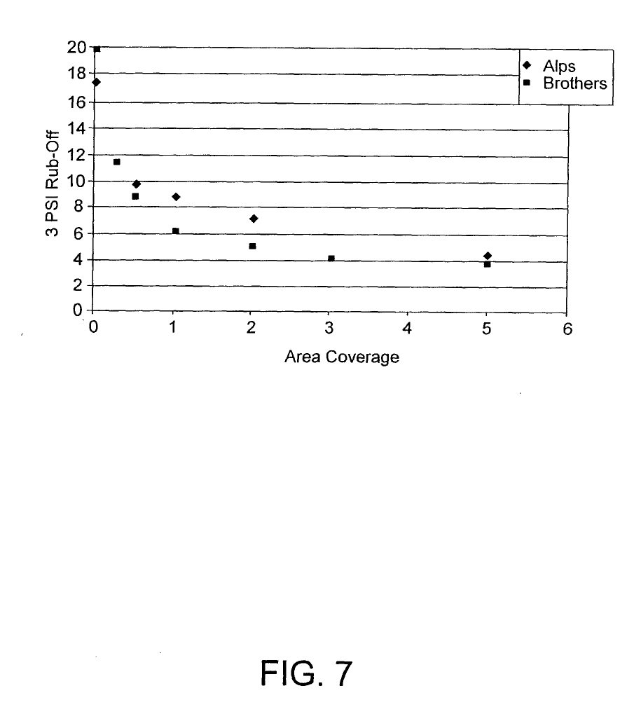

### RELATED APPLICATIONS

This application is entitled to and herby claims the benefit of U.S. provisional application Serial No. 60/310,887 filed Aug. 8, 2001.

### FIELD OF THE INVENTION

This invention relates to a method for reducing rub-off from a substrate, such as paper, having a toner image on at least one side of the substrate by depositing a plurality of dots or a thin coating of a substantially clear phase change composition on the side of the substrate bearing the image.

### BACKGROUND OF THE INVENTION

In electrophotographic printing, digital copying, and copying processes, images are formed on selected substrates, typically paper, using small, dry, colored particles called toner. Toner usually comprises a thermoplastic resin binder, dye or pigment colorants, charge control additives, cleaning aids, fuser release additives and optionally, flow control and tribocharging control surface treatment additives.

The thermoplastic toner is typically attached to a print substrate by a combination of heating and pressure using a fusing subassembly that partially melts the toner into the paper fibers at the surface of the paper substrate. Additionally, the fused toner image surface finish can be controlled by the surface finish on the surface of the fuser roller. Thus, the gloss of the image may be controlled between diffuse (low gloss) and specular (high gloss). If the surface finish of the image is rough (diffuse) then light is scattered and image gloss is reduced.

Typically, in an electrophotographic printer, a heated fuser roller is used with a pressure roller to attach toner to a receiver and to control the image surface characteristics. Heat is typically applied to the fusing rollers by a resistance heater such as a halogen lamp. Heat can be applied to the inside of at least one hollow roller, and/or to the surface of at least one roller. At least one of the rollers is typically compliant. When the rollers of a heated roller fusing assembly are pressed together under pressure, the compliant roller deflects to form a fusing nip. Most heat transfer between the surface of the fusing roller and the toner occurs in the fusing nip. In order to minimize “offset,” which is the amount of toner that adheres to the surface of the fuser roller, release oil is typically applied to the surface of the fuser roller. Typically, the release oil is silicone oil plus additives that improve attachment of the release oil to the surface of the fuser roller and dissipate static charge buildup on the fuser roller or fused prints. Some of the release oil becomes attached to the image and background areas of the fused prints.

Fused toner images can be substantially abraded or “rubbed-off” by processes such as duplex imaging, folding, sorting, stapling, binding, filing and the like. Residue from this abrasion process causes objectionable and undesirable marks on non-imaged areas of adjacent pages or covers. This process, and image quality defect, are known as “rub-off” and exist to varying extents in many electrophotographic copies and prints. The basic “requirements” for generation of rub-off are a donor (toner image), a receptor (adjacent paper page, envelope, mailing label, etc.), a differential velocity between donor and receptor, and a load between donor and receptor.

In general, mechanisms of rub-off are consistent with those of abrasion and adhesive wear mechanisms. Relevant factors include: toner toughness, toner brittleness (cross-linking density), surface energy or coefficient of friction of the toner, adhesion of the toner to the paper substrate, cohesive properties of the toner itself, the surface topography of the toner image, the level of load and the differential velocities of the wearing surfaces. Some of these factors are under the control of the machine and materials manufacturers, and some are under the control of the end user.

Toner rub-off may be reduced by the use of tougher toner, lower surface energy toner materials (resulting in lower coefficient of friction), better-fused toner, and a smoother toner image surface finish (but this increases image gloss.)

Unfortunately, there are undesirable consequences associated with each of the above rub-off reduction factors. A tougher toner is more difficult to pulverize, grind, and classify which increases manufacturing costs. Additionally, smaller toner particle size distributions are more difficult to achieve with tougher toner. Adding wax to the toner may provide additional release properties from the fuser roller surface, and add lubrication to the surface of the toner, but triboelectric charging behavior may be adversely affected. A more easily fusible toner may create more toner offset to the surface of the fuser rollers, or increase the tendency of fused prints or copies to stick together in the finisher or output trays. Creating a more specular (smoother) image surface finish increases image gloss, which may be objectionable in some applications. Fuser release oil can lower the coefficient of friction of the fused image, but this affect is temporary since the oil is adsorbed into the paper substrate over time. Fuser release oil can also cause undesirable effects in the rest of the electrophotographic process, especially in duplex printing operations.

Extensive efforts have been directed to the development of improved methods for reducing rub-off without modification of the fusing process. Such methods have included attempts to deposit a colorless phase change composition on a substrate bearing toner images. The phase change compositions used are similar to those used in ink jet printers but without pigment and other commonly used additives. These compositions require modification for use in the reduction of rub-off in that desired properties must be present in the phase change composition and at least one friction-reducing additive should be present in the phase change composition. Additional additives commonly used in ink jet printing for instance are not required. The phase change composition may be applied to the substrate in a variety of ways, such as by ink jet printers, by ribbon printers, either thermal or laser jet, by spraying, brushing or the like. The phase change composition may be applied to the substrate as a plurality of pixels or other small deposits of the phase change material spaced over the face of the substrate to reduce rub-off. The pixels or other small deposits of phase change material may also be positioned over the letters or other images formed by the toner on the substrate and the like. The phase change composition may be applied to the substrate by brushing, spraying and the like. A variety of techniques for depositing the phase change material on the substrate bearing the toner images are possible. In all such instances, it is believed that common properties will be desired in the phase change composition to achieve optimum rub-off reduction. Accordingly, efforts have been directed to the development of a phase change composition suitable for rub-off reduction from a substrate bearing a toner image.

### SUMMARY OF THE INVENTION

According to the present invention, an enhanced phase change composition for rub-off reduction from a substrate bearing a toner image consists essentially of at least one polymeric material, wax or blends thereof in combination with a friction reducing material with the combined materials having a melting point from about 80 to about 130° C., a melting point range of less than about 15° C., a static coefficient of friction less than about 0.62, a crystalline form as a solid, and being substantially odorless as a solid.

### DESCRIPTION OF THE PREFERRED EMBODIMENTS

Many electrophotographic processes produce prints or copies, which have a high rub-off of toner onto adjacent receiver sheets that is considered unacceptable by some users. The amount of rub-off depends upon the particular machine hardware, oiling rates and the like. Typical values from 19 to 25 are measured at 3 psi (pounds per square inch) using the test procedure described herein for copies that have been aged for about 100 hours.

The existing toners in some instances do not have a wax lubricant and offer little protection against rub-off. The electrophotographic process typically forms images on selected substrates, which are typically paper, using small, dry, colored particles called toner. Toners usually comprise a thermoplastic resin binder, dye or pigment colorants, charge control additives, cleaning aids, fuser release additives and, optionally, flow control and tribocharging control surface treatment additives.

Phase change compositions for use in rub-off reduction of electrophotographic toner images do not require surfactant, dispersants, colorants and the like. Desirably, these compositions are substantially colorless. Substantially colorless refers to a degree of transparency such that a user of the copying process would not observe the presence of the colorless hot melt composition on the substrate bearing the toner images.

Many phase change compositions are known for use in ink jet printers with surfactants, dispersants, dyes and the like. These materials have a relatively wide range of permissible properties. While certain of the these phase change compositions may be effective for use in rub-off reduction, by no means are all of the compositions suitable for use in ink jet printers suitable for rub-off reduction. Particularly, a phase change composition for rub-off reduction should adhere to the substrate and produce a small mound of the composition of approximately the same height of the toner images. Deposits of greater height can be used if desired and the material may alternately be spread over the entire substrate surface in a thin layer by brushing, spraying or the like.

The images on the substrate may be protected by a combination of supporting the adjoining substrate slightly above the surface of the substrate bearing the toner images and by partial destruction of the phase change composition deposits which may serve as sacrificial pylons by a reduction of friction between the image-bearing substrate and the receiving material and the like. In such instances, it is clear that the phase change composition must have sufficient fluidity at the deposition temperature to form pylons, an even coating or the like. This coating or deposit must be adherent to the substrate and be of sufficient strength to provide meaningful rub-off protection. It is also desirable that the phase change composition have a static coefficient of friction less than about 0.62. Preferably this value is less than about 0.50.

In general, the enhanced phase change composition consists essentially of at least one polymeric wax or blends thereof, having a melting point from about 80 to about 130° C., a melting point range of less than about 15° C., a crystalline form as a solid, a static coefficient of friction less than about 0.62, and being substantially odorless as a solid in combination with from about 10 to about 20 percent of a friction reducing material.

These compositions are preferably crystalline to enable a low gloss; therefore relatively high melting point waxes with sharp melting point ranges are desirable. Preferably the waxes or other polymeric materials used have a melting point from about 80 to about 130° C. with a melting range (starts-to-melt to starts-to-freeze) range of about 15° C. and preferably about 10° C. Desirably, these waxes or other polymeric materials are crystalline in solid form and have a low coefficient of friction and are odorless. Some particularly suitable materials are waxes, polyethylene, polyalphaolefins, and polyolefins. Other materials are shown below in the various patents discussed.

U.S. Pat. No. 5,958,169 discloses various hot wax compositions for use in ink jet printers. U.S. Pat. No., 6,018,005 discloses the use of urethane isocyanates, mono-amides, and polyethylene wax as hot melt wax compositions. The polyethylene is used at about 30 to about 80 percent by weight and preferably has a molecular weight between about 800 and about 1200.

U.S. Pat. No. 6,028,138 discloses phase change ink formulations using urethane isocyanate-derived resins, polyethylene wax, and a toughening agent. U.S. Pat. No. 6,048,925 discloses urethane isocyanate-derived resins for use in a phase change ink formulation. Both of these references disclose the use of a hydroxyl containing toughening agent.

Additional formulations are disclosed in U.S. Pat. Nos. 5,922,114; 5,954,865; 5,980,621; 6,022,910; and, 6,037,396.

U.S. Pat. No. 5,994,453 discloses phase change carrier compositions made by the combination of at least one urethane resin, at least one urethane/urea resin, at least one mono-amide and at least one polyethylene wax. This reference discloses further that the polyethylene may be employed as an overcoat on a printed substrate. The overcoat is supplied to protect from about 1 to about 25 percent of the surface area of the printed substrate. The treatment is disclosed to give enhanced anti-blocking properties to the prints and to provide enhanced document feeding performance of the ink-bearing substrates for subsequent operations, such as photocopying. This reference discloses the use of printing comprising images of phase change waxes, which are treated by over-spraying the substrate bearing the images of phase change waxes. The reference does not address in any way the treatment of substrates bearing toner images. Toner images, as discussed above, are radically different than phase change ink images in their properties. Further, this reference does not address the reduction of rub-off of toner images.

All of the patents noted above are hereby incorporated in their entirety by reference.

According to the present invention, the polymeric material wax or blends thereof are mixed with about 10 to about 20 percent of a friction reducing material. Suitable friction reducing materials comprise a wide range of materials known to those skilled in the art to reduce friction in such applications. Some suitable materials are polyfluorinated compounds such as polytetrafluoroethylene, polyfluoro-polyethylene, dry-film lubricants such as molybdenum disulfide, and graphites, organic sterates, inorganic sterates and fatty acid amides.

Some particularly preferred friction reducing material is erucamide, or cis-13-docosenoamide, with the molecular formula CH₃(CH₂)₇—CH═CH—(CH₂)₁₁CONH₂. Desirable results have been achieved with this material in concentrations from 10 to 20 percent based upon the weight of the total composition.

Another preferred friction-reducing material is stearyl stearamide or n-ctadecyloctadecanamide with the molecular formula CH₃(CH₂)₁₇—NH—CO(CH₂)₁₆CH₃. Desirable results have also been achieved with this material.

Evaluation of friction reducing materials with particular formulations selected for use for rub-off reduction is well within the skill of those in the art.

While it is desirable that the friction reducing material be present in a range from about 10 to about 20 percent, amounts outside this range may be suitable with a variety of friction reducing materials. As indicated, the evaluation of friction reducing materials with particular polymer, wax and other compositions useful for rub-off is well within the skill of those in the art. For instance, not only organic but also inorganic stearates such as zinc or lithium stearate are considered to be suitable as friction reducing compounds.

Further the composition may comprise waxes which are selected from the group consisting of paraffins, microcrystalline waxes, polyethylene waxes, ester waxes, fatty acids, sulfonamide waxes, tall oil resins, rosin esters, synthetic resins and mixtures thereof. These materials are well known to those skilled in the art and need not be discussed further.

As indicated previously, the phase change composition may be applied to a substrate by a variety of techniques such as ink jet printing, ribbon printing, either thermal or laser jet, direct spraying onto the substrate, brushing onto the substrate and the like. The enhanced phase change composition of the present invention is considered to be effective with all such methods of application.

In the test described in Examples 1 and 2, a test procedure for rub-off was used as follows.

Test Procedure

The Test Procedure used basically involves the use of a selected weight positioned on top of a receiver sheet, which is a clean sheet of paper positioned above a toner image-bearing sheet. The toner image-bearing sheet is then slid a controlled distance under the weight on the upper sheet. The resulting discoloration of the upper sheet is then compared to a standard to produce a numeric indication of the degree of rub-off. The degree of rub-off from a clean sheet is 3.0. The rub-off of untreated toner image-bearing copies is typically from about 19 to about 25. Typically, a standard test pattern is used to test the efficiency of the dot distribution. The test sheets used for the tests herein are referred to in the copying industry as Gutenberg sheets. These sheets are sheets of alternating very closely spaced lines of images of varying sizes. Desirably, a standard image of this type is used for all tests. The rub-off reduction applied is then readily evaluated for efficacy in reducing rub-off. As indicated above, the weight used for all tests in the application was 3 psi and the tests were performed by comparing all of the samples to the same set of standards to determine rub-off evaluation numbers.

Further, rubbed patches resulting from the tests were analyzed as follows:

a) six rub-off patches were produced for each test. The test patches were first scanned on a calibrated scanner with the resulting scans or image being saved using a standard format;

b) the patch image was then evaluated and a standard deviation of the density values from each patch is calculated. Applications such as Pro Shop or Math Cad can be used. It has been demonstrated that the results are identical.

The standard deviation, so long as the mean density is below 0.30, has been shown to correlate with the subjective measures or the amount of toner on the sheets evaluated;

c) the standard deviations of each patch were then averaged and the statistics provided for the test samples; and,

d) the average of six standard deviations was reported as the rub-off value for any particular test.

The test sheets, as indicated, are sheets with densely spaced images across the surface of the paper. To avoid any tendency to form streaks in the test apparatus, the paper was turned to an angle of 7 (seven) degrees relative to the direction of movement relative to the top clean sheet. The 7-degree angle has been selected arbitrarily and can be any suitable angle so long as the printed sheet is turned to a sufficient extent to avoid a tendency to streak as results of pulling the same letters of the sheet under the weighted area of the clean test sheet along the path of the test sheet.

### EXAMPLE 1

A suitable test method is disclosed in U.S. Patent application, U.S. Ser. No. 09/804,863 filed Mar. 13, 2001 by John Lawson, Gerard Darby, and Joe Basile, entitled Rub-off Test Method and Apparatus.

In a first test, a composition comprising a polyethylene wax having a molecular weight 00, a melting point of 88° C., a melt viscosity of about 5 at 149° C., and a penetration of 6.5 at 25° C. in combination with erucamide in a 90:10 ratio was deposited on a substrate bearing toner images by an ink jet printer at the area coverages shown below in Table 1. The erucamide was used in a ratio of 90:10 and in a ratio of 80:20. Further a stearyl stearamide was tested with the same wax in a ratio from 90:10. The enhanced materials were applied in a random dot pattern using a 300×300 cross-track to in-track dot per inch print head resolution using an ink jet printer. These results are reported below in Table 1. It will be clear that improved rub-off reduction was achieved by the use of the friction-reducing materials, particularly at the higher concentrations of erucamide. Clearly the use of the enhanced composition containing the friction reducing materials is effective to reduce rub-off. All tests shown in Table 1 were run using the test procedure described above.

TABLE 1

| | RUB-OFF | RUB-OFF | RUB-OFF |
|---|---|---|---|
| Area Covered | Wax + 10% | Wax + 10% Stearyl | Wax + 20% |
| % | Erucamide | Stearamide | Erucamide |
| 0.25 | 7.6 | 7.8 | 7.3 |
| 0.50 | 5.7 | 5.6 | 5.8 |
| 1.00 | 5.2 | 5.0 | 4.8 |
| 2.00 | 4.0 | 3.5 | 3.9 |
| 3.00 | 3.5 | 3.0 | 3.2 |
| 5.00 | 3.1 | 2.9 | 2.9 |

### EXAMPLE 2

In a second series of tests, a polyethylene wax including 10 percent erucamide, was tested. The enhanced materials was applied in a random dot pattern using a 300×300, 150×300, 100×300, 75×300, and 50×300 cross-track to in-track dot per inch print head resolutions using an ink jet printer. The areas covered and the rub-off test results for the various print resolutions are shown in Table 2. By observation of Table 2, it will be noted that the wax alone provides less rub-off protection than the wax in combination with the friction reducing material for all print resolutions. The rub-off values given in Table 2 are good to +−0.15.

TABLE 2

| | | RUB-OFF + | RUB-OFF + | RUB-OFF + | RUB-OFF + | RUB-OFF + |
|---|---|---|---|---|---|---|
| | RUB-OFF | 10% | 10% | 10% | 10% | 10% |
| % Area | Wax | Erucamide | Erucamide | Erucamide | Erucamide | Erucamide |
| Covered | 300 × 300 | 300 × 300 | 150 × 300 | 100 × 300 | 75 × 300 | 50 × 300 |
| 0.5 | 7.4 | 6.0 | 6.2 | 6.1 | 5.8 | 7.1 |
| 1.0 | 5.5 | 5.2 | 4.7 | 4.5 | 4.9 | 5.4 |
| 2.0 | 4.3 | 4.0 | 3.7 | 4.0 | 3.8 | 3.9 |

All rub-off tests in both Example 1 and 2 were conducted at 3-psi pressure. Having disclosed the present invention by reference to certain of its preferred embodiments, it is respectfully pointed out that the embodiments described are illustrative rather than limiting in nature and that many variations and modifications are possible within the scope of the present invention. Many such variations and modifications may be considered obvious and desirable by those skilled in the art based upon the foregoing description of preferred embodiments.

Having thus described the invention, I claim:

1. An enhanced phase change composition for rub-off reduction from a toner image-bearing substrate, the composition consisting essentially of at least one polymeric material, wax or blends thereof, and a static friction reducing material and having a melting point from about 80 to about 130° C., a melting point range less than about 15° C., a static coefficient of friction less than about 0.62, a crystalline form as a solid and being substantially odorless as a solid.

2. The composition of claim 1 wherein the melting range is less than about 10° C.

3. The composition of claim 1 wherein the static coefficient of friction is less than about 0.5.

4. The composition of claim 1 wherein the friction reducing material is selected from the group consisting of organic sterates and or fatty acid amides.

5. The composition of claim 1 wherein the friction reducing material is present in an amount equal to from about 10 to about 20 weight percent based upon the weight of the composition.

6. The composition of claim 1 wherein the friction reducing material is present in an amount equal to from about 12 to about 18 weight percent based upon the weight of the composition.

7. The composition of claim 1 wherein the friction reducing material is erucamide.

8. The composition of claim 7 wherein the friction reducing material is present in an amount from about 10 to about 20 weight percent based upon the weight of the composition.

9. The composition of claim 1 wherein the friction reducing material is a stearyl stearamide.

10. The composition of claim 9 wherein the friction reducing material is present in an amount from about 10 to about 20 weight percent based upon the weight of the composition.

11. The composition of claim 1 wherein the polymeric material is selected from polyethylene, polyalphaolefins and polyolefins and mixtures thereof.

12. The composition of claim 1 wherein the friction reducing material is an organic stearate.

13. The composition of claim 1 wherein the friction reducing material is an inorganic stearate.

14. The composition of claim 13 wherein the inorganic stearate is zinc or a lithium stearate.
